(19) United States
(12) Patent Application Publication
(10) Pub. No.: US 2017/0241467 A1
(43) Pub. Date: Aug. 24, 2017

(54) Screw fitting for the passage of fluids, equipment and method for its production

(71) Applicant: A. AGRATI S.P.A., Veduggio Con Colzano (MB) (IT)

(72) Inventor: Enrico Cazzamani, Avigliana (Torino) (IT)

(73) Assignee: A. AGRATI S.P.A., Veduggio Con Colzano (MB) (IT)

(21) Appl. No.: 15/512,835

(22) PCT Filed: Feb. 19, 2016
(86) PCT No.: PCT/EP2016/000289

§ 371 Date: Mar. 20, 2017

(30) Foreign Application Priority Data
Feb. 25, 2015 (IT) MI2015A000282
Feb. 15, 2016 (IT) 102016000015154

(51) Int. Cl. F16B 37/08; F16B 33/02; F16L 27/093

(52) U.S. Cl. CPC F16B 37/085; F16L 27/093; F16B 33/02

(57) ABSTRACT

A screw fitting for the passage of fluids includes a stem and an enlarged head positioned at an end of the stem the stem being at least partially provided with a threaded portion that includes at least a throat for the passage of a fluid, formed on an outer portion of the stem and extending at least through the threaded portion.

### TECHNICAL FIELD

The present invention relates to the field of screw fittings for the passage of fluids, between different elements, typically an intake system (tube) and an implementation system (cylinder).

### STATE OF THE ART

In the state of the art, every time a hydraulic tube must be connected to an actuator, passages must be envisaged for a fluid in the connection element: it contemporaneously exerts, in fact, the function of a passage for the fluid and that of a mechanical coupling between the tube and actuator.

As a first example, and with reference to FIG. 1, the case can be considered of the braking circuit of a vehicle: the coupling of the tube T, which carries the oil to the brake pliers (actuator), is effected by means of an eyelet fitting R in which a screw V provided with a duct V1, V2 for the passage of the oil, is housed; the eyelet fitting R is connected and in fluid communication with the tube T, whereas the threaded portion VF of the screw V is engaged on a threading of the actuator (in the example produced on the body of the brake pliers and not shown).

Other non-limiting examples of analogous installations are present in turbo-compressors or more generally in hydraulic circuits in both the car industry and in the field of construction vehicles (loaders, excavators, etc.) and also in production plants.

The known screw V comprises a stem VS and an actuation head VT, enlarged with respect to the stem VS, and the passage duct develops with two distinct sections: a first section, axial, V1 inside the stem and a second section, radial, V2 in communication with the first section, which ends above the threaded portion of the stem, between this and the head VT, so as to put the duct V1, V2 in fluid communication with the internal volume of the eyelet fitting R and therefore with the tube T, on the one hand, and with the actuator, on the other.

Although these types of screw fitting are generally functional and widely used, they are not without drawbacks.

A first drawback is closely related to the production method, by means of chip removal (once the screw V has been produced, the ducts V1 and V2 are formed by axially and radially perforating the screw V itself).

In short, this results in lower mechanical characteristics with respect to a full screw having the same dimensions, associated with the presence of cut fibres, with a consequent lower value of the,breaking torque and therefore operating value.

This leads to the risk of damaging the screw during assembly or the necessity of suitably over-dimensioning it.

Another drawback is linked to the risk of contamination of the ducts V1, V2 (especially in the intersection area of the axial hole V1 and radial hole V2) due to the potential presence of non-evacuated chips, as the washing is difficult mainly due to geometry (small diameters and ducts V1 and V2 intersecting at a right angle).

A further drawback lies in the high pressure drops that are generated in the intersection area of the axial hole V1 and the radial hole V2. Yet another problem consists in the difficulty of creating imprints for tools different from standard tools (e.g. hexagonal heads).

Another drawback lies in the fact that there is a high consumption of raw material (with a consequent increase in costs), as manufacturing with chip removal inevitably leads to the production of chips and therefore waste material.

A further problem of these known solutions lies in the fact that the overall fluid flow-rate is associated with the screw dimensions and cannot be increased unless the dimensions of the stem are correspondingly increased (with the same robustness), viceversa the axial passage duct would inevitably be too wide and there would be an excessive reduction in the mantle wall of the stem.

Other solutions known in the state of the art are described in DE 10 2012 110986 in the name of AUDI AG, which discloses a threaded connection that has a groove extending helically on the stem of the bolt. Said bolt is produced for chip removal starting from a metallic cylindrical semi-finished product, as can be easily observed from an analysis of FIG. 17 of said document, in which it can be clearly seen that the diameter of the threaded part is reduced with respect to the small cylindrical shank in a position adjacent to the head; this detail is fundamental for understanding how the bolt has been produced.

Chip removal processing has various drawbacks as it can leave processing residues which, if the component were used in a braking system of a vehicle, could cause dangerous malfunctioning of the system.

Another known solution is that described in GB 563,016 in the name of Wantoch: this solution envisages a straight cavity which extends on the stem of the bolt.

The straight cavity, however, hinders the screwing and can only be produced moreover, also in this case, by milling, with the same drawbacks discussed above; furthermore, the straight cavity requires that the thread be produced by chip removal.

From what is specified above, it is clear that in the state of the art, for producing a cavity on a threaded connection (e.g. bolt), it is standard practice to produce it by milling the threaded part produced (in turn) by chip removal.

From a strictly plant engineering point of view, this approach is, moreover, logical, as the same machine can be used for producing both the threading and the cavity, reducing both the number of machines required and also the set-up operations of the same and insertion of the piece in the machine.

As already mentioned, however, this manufacturing method does not provide completely satisfactory results, first of all due to the refinishing of the threaded connection itself and secondly because effecting two milling operations (for the separate production of the thread and cavity) may require a change of tool and two distinct consecutive operations.

### OBJECTIVES AND SUMMARY OF THE INVENTION

An objective of the present invention is to overcome the drawbacks of the known art.

In particular, an objective of the present invention is to provide a screw fitting for the passage of fluids comprising a stem and an enlarged head positioned at an end of the stem, wherein the stem is at least partially provided with a threaded portion, which is relatively simple and economic to produce.

A further objective of the present invention is to provide such a fitting wherein the passage of the fluid is subject to reduced pressure drops.

Another objective of the present invention is to provide such a fitting that is robust.

Yet another objective of the invention is to provide a method for manufacturing said fitting which is relatively simple to implement, relatively economic and which produces fittings which do not require particular cleaning processings after production.

A further objective of the invention is to provide equipment, in particular mechanical equipment, which is capable of implementing said method for producing said fitting.

These and other objectives of the present invention are achieved by means of a fitting, a production method and production equipment according to the respective enclosed independent claims, each also optionally having the characteristics of the respective enclosed subclaims, which form an integral part of the present description.

A first idea at the basis of the invention is to produce both the throat for the passage of the fluid and the threading by means of plastic deformation operations of a metallic semi-finished product.

This solution offers the advantage of availing of a screw fitting with improved mechanical characteristics with respect to known fittings, thanks to the cold moulding process with respect to the standard solution by means of lathing (chip removal); the advantage is a direct consequence of the presence of non-cut fibres, with a consequent higher breaking torque and operating value of the fitting itself.

Another advantage is linked to the fact that contamination of the fluid passage can be avoided due to the manufacturing process which is different from chip removal, as it is effected through plastic deformation.

Yet another advantage lies in the reduced pressure drop obtained in the fittings thus produced.

A further advantage is linked to the simplicity of maintaining an adequate cleaning level, due to the lack of blind holes and intersection of the ducts of the solutions known in the state of the art.

An additional advantage is associated with the possibility of creating keys or imprints for tools different from standard tools, for example a proprietary imprint or anti-tampering key.

Yet another advantage lies in the fact of having a low consumption of raw material and a consequent cost reduction as there is no waste material.

A further advantage is linked to the possibility of assembly with washers, irremovable with respect to the screw with the creation of the thread by deformation.

Another advantage is having a wide variability of the fluid flow-rate, that can be obtained without reducing the overall robustness of the fitting.

A first object of the invention therefore relates to a screw fitting for the passage of fluids comprising a stem and an enlarged head positioned at an end of the stem, the stem being at least partially provided with a threaded portion, comprising at least a throat for the passage of a fluid, produced outside the stem which extends at least through the threaded portion, wherein the throat has a helical development around said longitudinal development axis of said stem, said stem comprising a smooth portion which extends between the enlarged head and the threaded portion, wherein the external diameter of the threaded portion is larger than the external diameter of the smooth portion, the threaded portion being produced by means of plastic deformation.

According to an optional characteristic, the throat extends through at least a part of the smooth portion.

According to an optional characteristic, alone or combined with the previous characteristic, the throat starts in correspondence with the smooth portion and ends in an area of the stem close to or coinciding with the threaded portion.

According to an optional characteristic, alone or combined with the previous characteristics, the screw fitting comprises a terminal truncated-conical portion of said stem, adjacent to the threaded portion and facing a free terminal end of the body opposite that coupled with the enlarged head, wherein said throat ends in correspondence with the terminal truncated-conical portion.

According to an optional characteristic, alone or combined with the previous characteristics, the throat has a depth greater than the depth of the threading of the threaded portion, so that it interrupts the threading in the co-existence area of the two.

According to an optional characteristic, alone or combined with the previous characteristics, the throat has a tilted or curved trend with respect to a longitudinal development axis of said stem.

According to an optional characteristic, alone or combined with the previous characteristics, the screw fitting comprises a plurality of said throats.

A further object of the invention relates to a method for producing a screw fitting for the passage of fluids, said screw fitting comprising a stem and an enlarged head positioned at an end of the stem, the stem being at least partially provided with a threaded portion, comprising at least a throat for the passage of a fluid, produced outside the stem which extends at least through the threaded portion, comprising the following consecutive steps:
f. preparing a metallic semi-finished product comprising: a stem of a semi-finished product, cylindrical and substantially smooth, and an enlarged head of a semi-finished product provided with at least an imprint for a tool,
g. forming, by means of a plastic deformation operation, at least a helical throat on at least part of said semi-finished stem,
h. forming, by means of a plastic deformation operation, a threaded portion on at least part of said stem of semi-finished product.

According to an optional characteristic of the method, before step g. the following generation steps of the metallic semi-finished product are envisaged, i.e.:
a. preparing a piece of metal wire having a pre-established length and diameter,
b. extruding said piece of wire for at least part of its length in order to create a stem of a semi-finished product with a diameter smaller than the diameter of the piece of wire and a head of a semi-finished product having a first diameter larger than the diameter of the piece of wire,
c. effecting a first swaging of said head of a semi-finished product until a second diameter which is larger than the first diameter, is obtained,
d. effecting a second swaging of said head of semi-finished product to create at least an external imprint thereon,
e. effecting a third swaging of said head to create at least an internal imprint for a tool, steps d. and e. being envisaged either alternatively or combined with each other.

According to an optional characteristic of the method, alone or combined with the previous characteristic, step g. comprises the following phases:
g1. preparing a moulding matrix comprising a perforated channel defined by peripheral walls in which there is at least one helical relief substantially complementary to the at least one helical throat to be formed on said stem of semi-finished product,
g2. inserting said stem of semi-finished product in said perforated channel,
g3. exerting a first axial force with respect to a longitudinal axis of said stem of semi-finished product, applied in correspondence with the head of semi-finished product and directed towards said matrix, said first force being at least sufficient for allowing at least part of the stem of semi-finished product to penetrate the perforated channel of the matrix, at the same time allowing said stem of semi-finished product free to rotate with respect to said matrix, so as to form the throat by means of plastic deformation of at least part of the stem of semi-finished product,
g4. exerting a second axial force with respect to a longitudinal axis of said stem of semi-finished product, applied in correspondence with a terminal end of said stem opposite that facing the head of semi-finished product, said second force being directed from the matrix towards the semi-finished product, said second force being at least sufficient for allowing the stem of semi-finished product to exit from the perforated channel of the matrix, at the same time allowing said semi-finished stem free to rotate with respect to said matrix, thus extracting the semi-finished product from the matrix.

According to an optional characteristic of the method, alone or combined with the previous characteristic, step h. comprises the following phases:
h11. preparing threading tools provided with specific threading profiles,
h2. inserting at least part of the stem of semi-finished product between said thread chasers,
h3. rolling said part of the stem of semi-finished product between said thread chasers to form a threaded portion by means of a plastic deformation operation.

A further object of the invention relates to equipment for implementing the method of the invention, comprising a moulding matrix, in turn comprising an perforated hole open on at least a side of the matrix and defined by peripheral walls from which at least one helical relief protrudes.

According to an optional characteristic of the equipment, it comprises a thrust tool facing said matrix on its side on which said perforated channel opens and suitable for exerting said first axial force with respect to a longitudinal axis of said semi-finished stem, applied in correspondence with the semi-finished head and directed towards said matrix, said thrust hammer being coupled with said semi-finished head rotatingly free.

According to a further optional characteristic of the equipment, alone or combined with the previous characteristic, it comprises an extraction pin at least partially roto-translatingly housed inside said perforated channel of the matrix and destined for exerting said second axial force, with respect to a longitudinal axis of said stem of, semi-finished product, in correspondence with a terminal end of said stem opposite that facing the head of semi-finished product.

### BRIEF DESCRIPTION OF THE DRAWINGS

The invention is described hereunder with reference to non-limiting examples provided for purely illustrative and non-limiting purposes in the enclosed drawings. These drawings illustrate different aspects and embodiments of the invention and, when appropriate, reference numbers illustrating structures, components, materials and/or similar elements in different figures are indicated by similar reference numbers.

In the enclosed figures:

FIG. 1 illustrates a screw fitting according to the known art;

FIGS. 2 and 3 illustrate different side views of a screw fitting according to the invention;

FIG. 4 illustrates a perspective view of a screw of the previous figures;

FIG. 5 illustrates a perspective view of the screw fitting of the previous figures assembled with an eyelet fitting;

FIG. 6 illustrates a view from below of the assembly of the previous figure;

FIGS. 7a-7m illustrate the production cycle of the semi-finished product and throat by means of plastic deformation of the semi-finished product according to the method of the invention for the production of the fitting of the invention;

FIGS. 8a-8d illustrate a time sequence for creating the threading by means of plastic deformation of the semi-finished product according to the method of the invention for the production of the fitting of the invention.

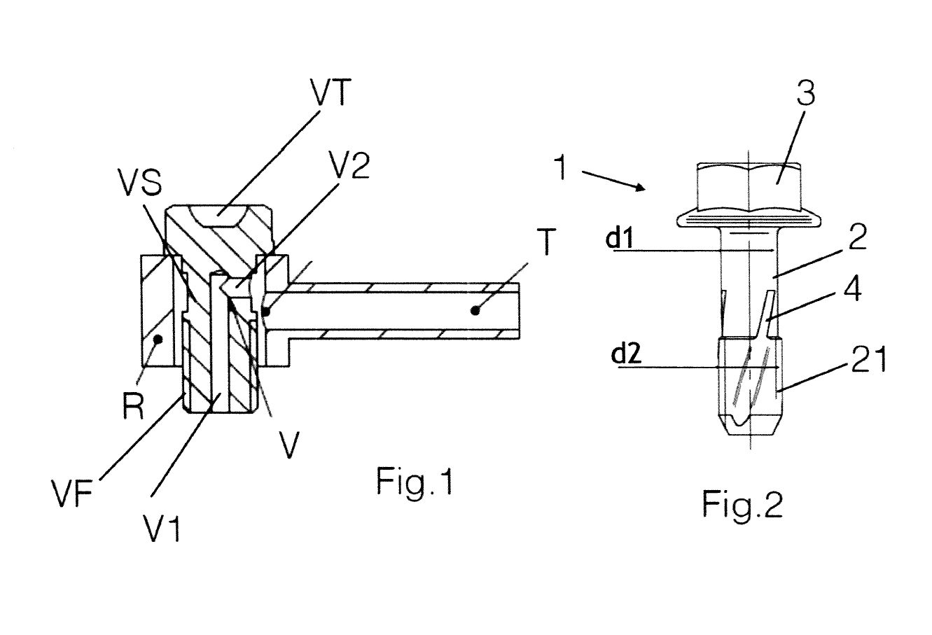

### DETAILED DESCRIPTION OF THE INVENTION

Whereas the invention can undergo various modifications and alternative constructions, some preferred embodiments are illustrated in the drawings and are described in detail hereunder.

It should be understood, however, that there is no intention of limiting the invention to the specific embodiment illustrated but, on the contrary, it intends to cover all the modifications, alternative constructions and equivalents that fall within the scope of the invention as defined in the claims.

The use of “for example”, “etc”, “or” indicates non-exclusive alternatives without any limitation unless otherwise specified.

The use of “comprises” means “comprises, but not limited to” unless otherwise specified.

Indications such as “vertical” and “horizontal”, “upper” and “lower” (without other indications) should be read with reference to the assembly (or operative) conditions and referring to normal terminology used in everyday language, wherein “vertical” indicates a direction substantially parallel to that of the force of gravity vector “g” and “horizontal” a direction perpendicular to the same.

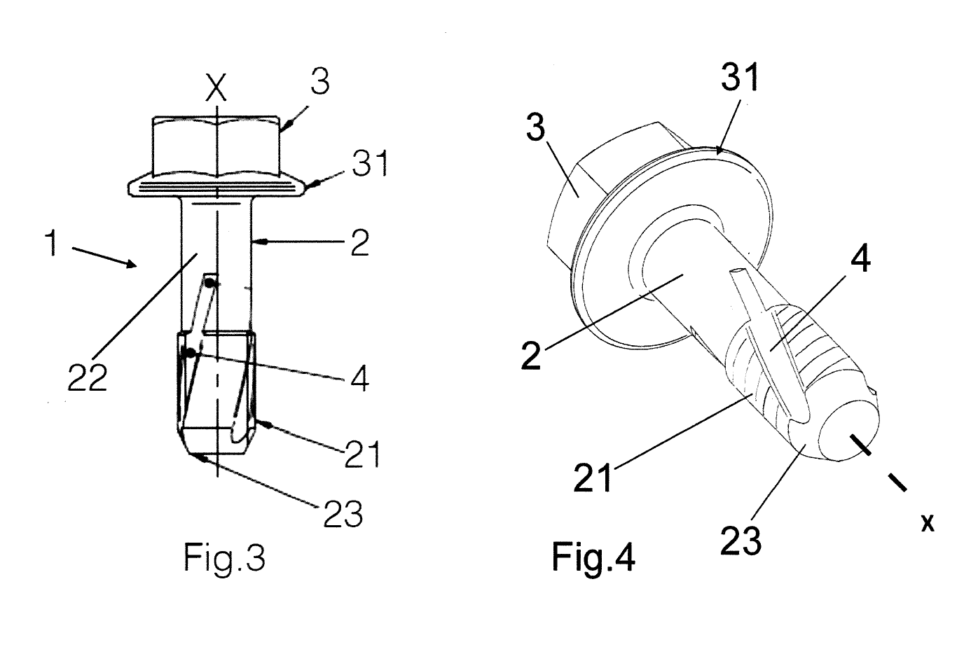

With reference to the enclosed FIGS. 2-4, these show, in various views, a non-limiting example of a screw fitting 1 for the passage of fluids according to the invention.

In this embodiment, the screw fitting 1 comprises a stem 2 and an enlarged head 3 positioned at an end of the stem 2.

In the embodiment, the head 3 has an enlarged flange 31 on the side facing the stem 2, but the flange 31 may also be absent in other embodiments.

The stem 2 is at least provided with a threaded portion 21, which, in the example, only extends for a part of the axial extension of the stem 2 itself; in other embodiments (not illustrated), the threaded portion, on the other hand, substantially extends along the whole stem 2.

Generally speaking, according to the disclosures provided herein, the screw fitting 1 comprises at least a throat 4 for the passage of a fluid; the throat 4 is produced outside the stem 2 and extends at least through the threaded portion 21.

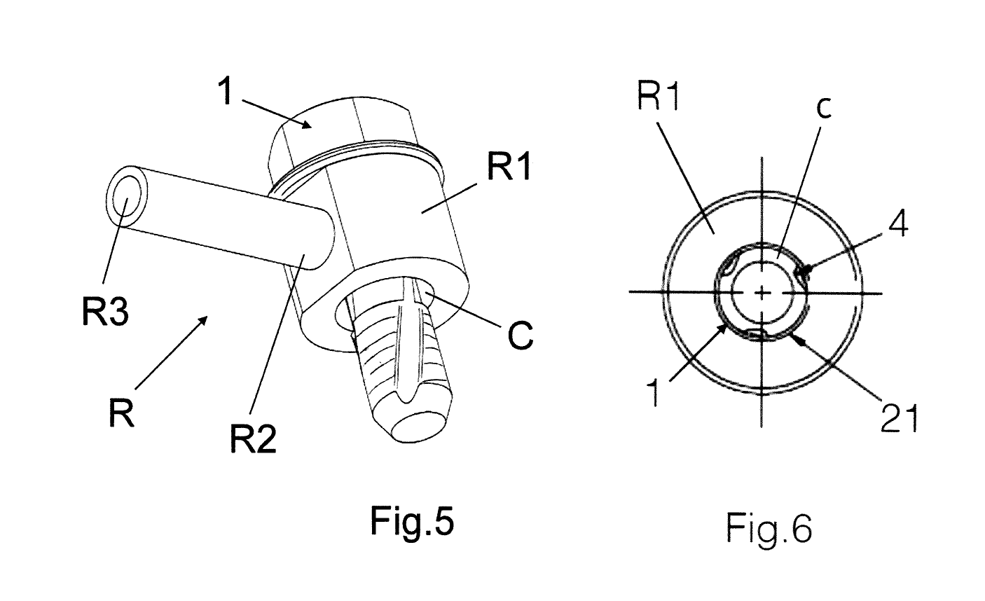

The throat 4 forms the duct in which the fluid passes in an operative condition of the fitting, as better described also in FIGS. 5 and 6.

In the embodiment shown, the stem 2 comprises a smooth portion 22 which extends between the enlarged head 3 and the threaded portion 21.

The outer diameter d1 of the smooth portion 22 is preferably smaller than that d2 of the threaded portion 21; this derives from the fact that in the fitting 1, according to the invention, both the throat 4 and the threaded portion 21 are produced by plastic deformation.

It should be noted, on the contrary, that a possible embodiment for chip removal (as in the cases of the state of the art) would inevitably cause the diameter d1 to be larger than the diameter d2.

The difference in diameters (d1<d2) not only clearly indicates that the threading 21 is effected by means of plastic deformation, but also has a synergic advantage: it allows, in fact, inter alia, a good fluid communication in an operative condition (in this respect, further details are provided in FIG. 5).

It should be observed that in this example, a plurality of throats 4 are envisaged, which extend through at least part of the smooth portion 22.

More specifically, each throat 4 starts in correspondence with the smooth portion 22 and ends in an area of the stem close to or coinciding with the threaded portion 21, extending without interruption of continuity between its beginning and end; each throat 4 preferably also extends onto the smooth or non-threaded portion 22, even more preferably at least as far as half of its length (longitudinal): this allows an improvement in the passage of the fluid, reducing pressure drops, especially when the fluid has a high density and/or viscosity.

In the example illustrated, the fitting 1 comprises a terminal truncated-conical portion 23 of the stem 2, adjacent to the threaded portion 21 and facing a free terminal end of the body 2 opposite that coupled with the enlarged head 3.

In this situation, each throat 4 terminates in correspondence with the terminal truncated-conical portion 23, to reduce pressure drops and allow an easier passage of the fluid, which, as it is often hydraulic oil, can have a high density and/or viscosity.

It can be noted from the enclosed figures that each throat 4 has a depth greater than the depth of the threading of the threaded portion 21.

The term “depth” indicates herein, the radial extension, starting from the outermost surface towards the longitudinal development axis X of the stem 2 (said axis coinciding, moreover, with the helicoid axis of the threading 21).

In this way, the same threading is interrupted by the throat in the coexistence areas of the threading 21 and the throat 4.

In general, each throat 4 has a tilted or curved trend with respect to the longitudinal development axis X of the stem 2.

Each throat 4 preferably has a helical development around the longitudinal axis X, different from the helical development of the threaded portion 21: the term “helical development” indicates that the pitch between the helicoids of the threaded portion 21 and that of the throat 4, is different, as also the depth.

The helical development of the throat 4, which must be coherent with the moulding technologies and consequently not all the angles can be admitted (e.g. 0°, 90° that can have any angle, has various additional advantages as, in addition to allowing the flow of the fluid/liquid, at the same time, it allows the formation of the screw thread by means of a plastic deformation process of the same, as explained in more detail hereunder.

In the case of a plurality of throats 4, they preferably extend parallel to each other.

With respect to the enlarge head 3, this has an imprint for a tool, preferably of the anti-tampering type, for example a “proprietary” imprint.

These profiles and/or imprints (that can be internal or external) are known per se in the state of the art and are based on the concept of guaranteeing that an intervention on the component can only be effected by a specifically authorized person for keys or tools suitable for being engaged with the screw head which, for this purpose, can have different engagement profiles from those normally used on the market.

This characteristic is particularly interesting in the case of safety components and/or with a high economic value.

A proprietary/anti-tampering profile can therefore be defined on the basis of necessity and can have infinite variations.

With reference to FIGS. 5 and 6, in these, the screw fitting 1 is assembled under operative conditions in a form that also comprises an eyelet fitting R.

The eyelet fitting R comprises an internally cylindrical portion R1 destined for receiving the screw fitting 1, in particular destined for housing at least the non-threaded portion 22, if the screw fitting 1 is provided with this.

The longitudinal length of the eyelet fitting (intended as the height of the cylindrical body of the same measured along the axis X) is preferably approximately equal to that of the non-threaded portion 22.

A tubular element R2 is connected to the internally cylindrical portion R1 of the eyelet fitting R, so as to create a passage duct for the fluid, said tubular element R2 terminating with a connection end R3 for coupling with a tube for transferring the fluid, such as hydraulic oil or the like.

Once the screw fitting 1 has been assembled with the eyelet fitting R, the throats 4 allow the passage of the fluid in the two directions: as can be seen, in fact, in the view of FIG. 6, the throats 4 allow the fluid sent into the eyelet fitting R to reach the free end of the screw fitting 1 and viceversa.

In this respect, with reference to FIG. 5, it should be noted that the difference between the diameters d1 and d2 (with d1<d2) deriving from the generation of the thread 21 by the plastic deformation of a semi-finished product, not only synergically allows problems linked to the presence of chips to be eliminated, but also creates an actual passage chamber C of the fluid, which allows pressure drops to be minimized.

The following, in fact, should be considered: in the eyelet fitting R, the cylindrical portion R1 is equipped with a central hole having a diameter at least equal (in reality slightly higher) to d2; this immediately derives from the assembly requirements, the threaded portion having a diameter d2 must in fact be inserted in the hole of the cylindrical portion R1.

When the screw fitting 1 is inserted—in an operative position—in the eyelet fitting R (as in FIG. 5), the cylindrical portion R1 of the latter is substantially superimposed with respect to the smooth portion 22 having a diameter d1 (smaller than d2): an annular chamber C is consequently created between the internal hole of the cylindrical portion R1 and the smooth portion 22, which completely surrounds the smooth portion 22 itself.

This optimally allows not only an airtight seal to be obtained, but also a condition for the passage of the fluid; in particular, when the fitting 1 is provided with the enlarged flange 31, the seal can possibly be effected between this and the cylindrical portion R1 also without the interpositioning of additional sealing elements.

Furthermore, even if a sealing washer is envisaged (not shown), assembled in correspondence with the smooth portion 22, this becomes irremovable thanks to the above difference in diameters d1 and d2: in this case the washer—having an internal diameter between d1 and d2—is inserted on the metallic semi-finished product before this is plastically deformed with the generation of the threading and—therefore—the larger diameter d2, so that said washer cannot be removed from the smooth portion.

Generally speaking, it should finally be remembered that, as an alternative, the throat 4 can have a tilted or curved trend according to an angle coherent with the technology used.

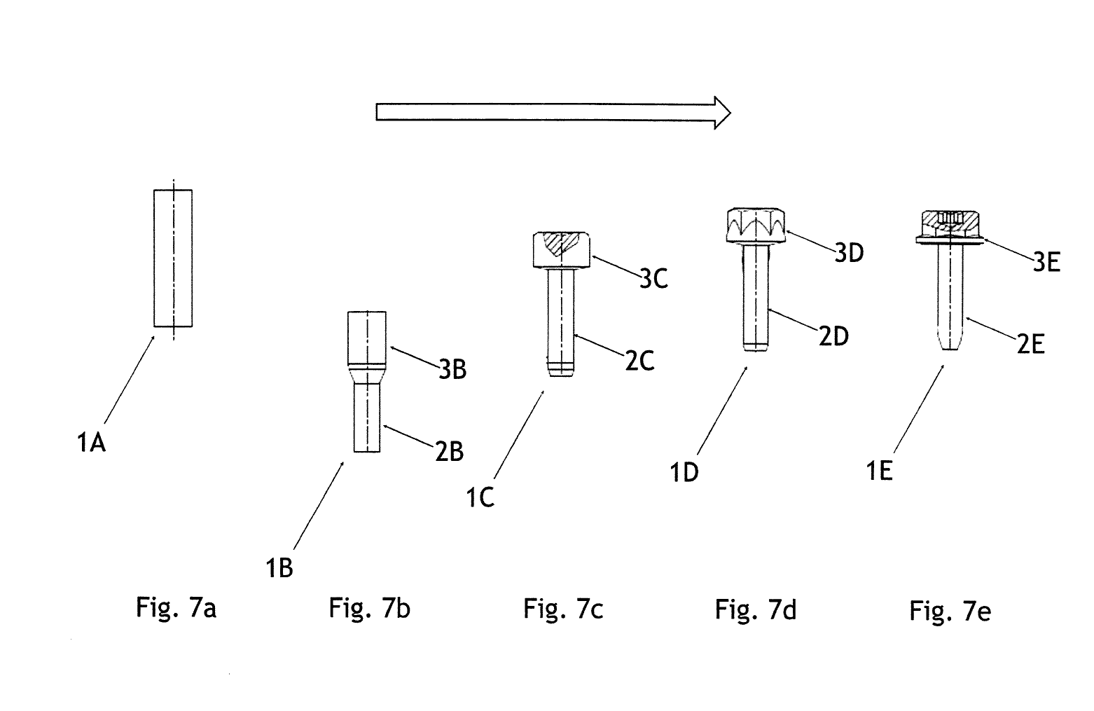

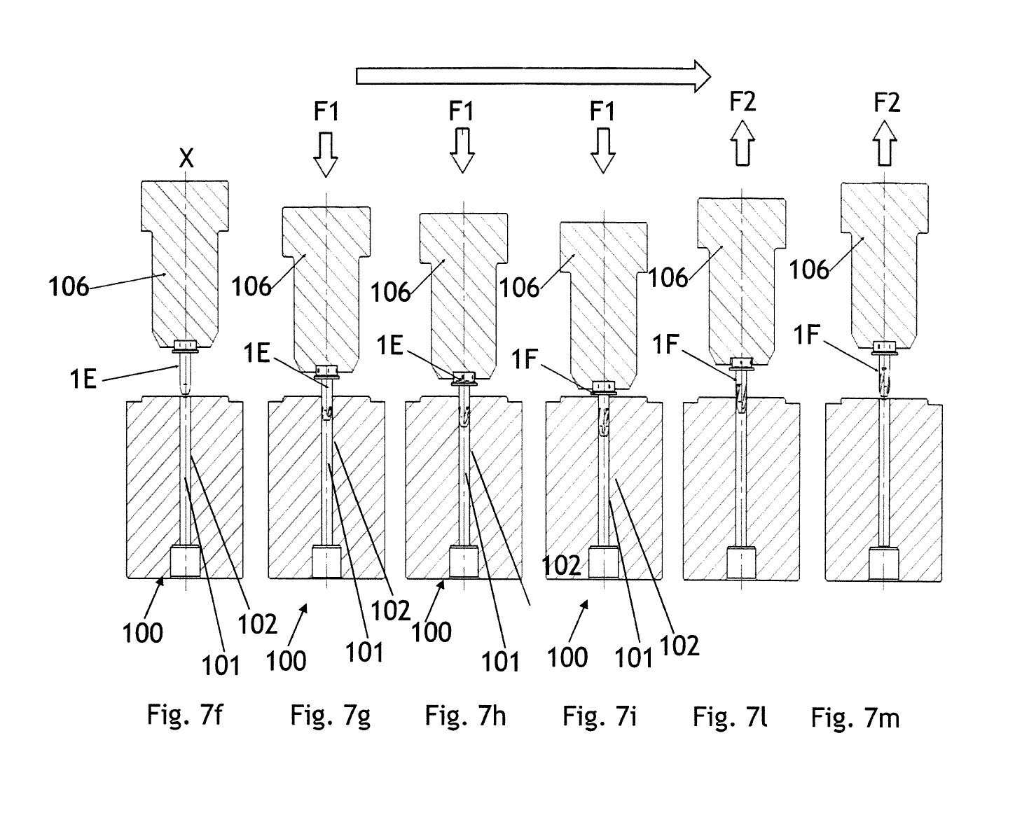

With reference to FIGS. 7a-9d, the production method of the fitting 1 described above, is described hereunder.

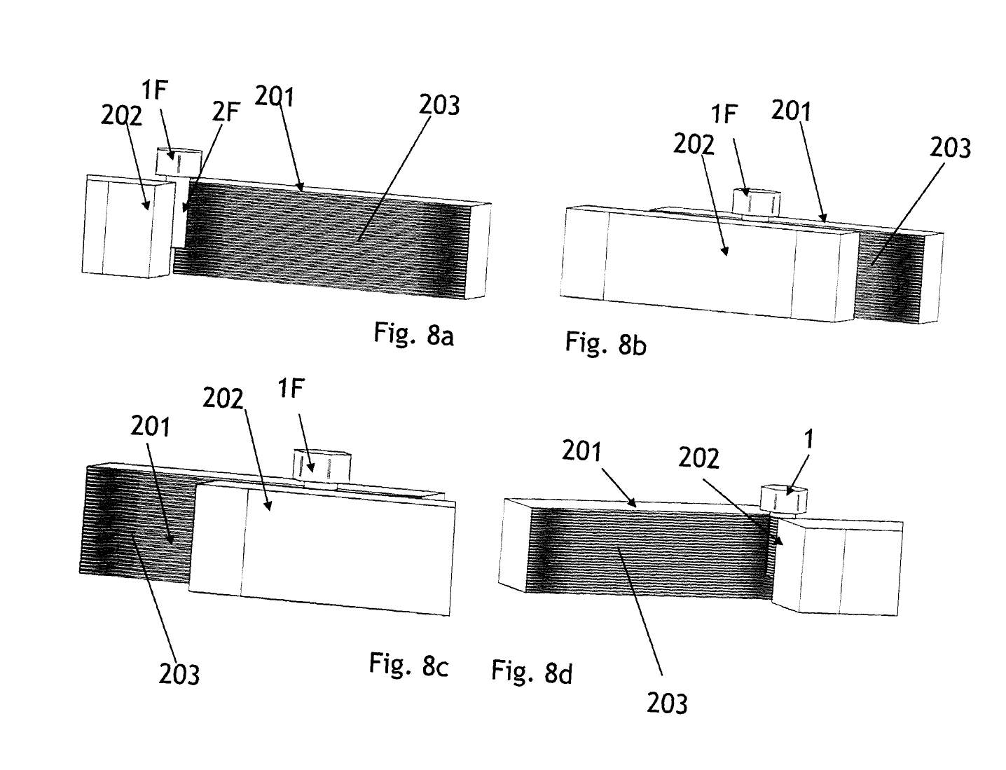

In its general features, the method for manufacturing a screw fitting 1 of the type described above, comprises the following consecutive steps:
f. preparing a metallic semi-finished product 1E comprising: a stem of semi-finished product 2E, cylindrical and substantially smooth, and an enlarged head of semi-finished product 3E provided with at least an imprint for a tool,
g. forming, by means of a plastic deformation operation (FIGS. 7f-7m), at least a helical throat on at least part of said stem 2E of semi-finished product, h. forming, by means of a plastic deformation operation (FIGS. 8a-8d), a threaded portion on at least part of said stem of semi-finished product 2E.

As far as the production of the semi-finished product 1E is concerned, in general, various embodiments can be envisaged.

It is particularly advantageous, with reference to FIGS. 7a-7m, for the metallic semi-finished product to be produced by means of the following steps:
a. preparing a piece of metal wire having a pre-established length and diameter (FIG. 7a),
b. extruding said piece of metal wire 1A for at least part of its length in order to create a stem of semi-finished product 2B with a diameter smaller than the diameter of the piece of wire 1A and a head of semi-finished product 3B having a first diameter larger than the diameter of the piece of wire 1A (FIG. 7b),
c. effecting a first swaging of said head of semi-finished product 3C until a second diameter which is larger than the first diameter, is obtained (FIG. 7c),
d. effecting a second swaging of said head of semi-finished product 3D to create at least an external imprint thereon (FIG. 7d),
e. effecting a third swaging of said head 3E to create at least an internal imprint for a tool (FIG. 7e).

It should be noted that in the example of FIGS. 7a-7e, the two steps of the method d. and e. are envisaged combined with each other, i.e. both are envisaged in the order indicated (first d. and then e.); in some variants of the method, only one of these may be envisaged alternatively (d. or e.) whereas in other variants the order may be inverted (first e. and then d.).

Together with the processing of the head of semi-finished product (which brings it from 3B to 3E), there is optionally also a processing of the stem from 2B to 2E with a possible variation, preferably a reduction in its diameter and optionally the formation of a truncated-conical terminal portion.

Turning now to an analysis of FIGS. 7f-7m, these show in detail, consecutive phases (from left to right) of a preferred embodiment of step g for forming at least one helical throat by means of a plastic deformation operation, on at least part of said stem 2E of the semi-finished product 1E.

In this embodiment, step g. comprises the following phases:
g1. preparing a moulding matrix 100 comprising a perforated channel 101 defined by peripheral walls 102 from which at least one helical relief protrudes, which is substantially complementary to the at least one helical throat 4 to be formed on said stem of semi-finished product 1E,
g2. inserting said stem of semi-finished product 2E in said perforated channel 101 (FIG. 7f),
g3. exerting a first axial force F1 aligned with a longitudinal axis X of said stem of semi-finished product 2E, applied in correspondence with the head of semi-finished product and directed towards said matrix 100, said first force being at least sufficient for allowing at least part of the stem of semi-finished product 2E to penetrate the perforated channel 101 of the matrix 100, at the same time allowing said semi-finished product 1E free to rotate with respect to said matrix 100, so as to form the throat 4 by means of plastic deformation of at least part of the stem of semi-finished product 2E (FIGS. 7g-7i), the reference number 1F indicates herein the semi-finished product 1E with the throats 4 formed.
g4. exerting a second axial force F2 with respect to a longitudinal axis X of the stem of semi-finished product 1F, applied in correspondence with a terminal end of said stem opposite that facing the head of semi-finished product 1F, said second force F2 being directed by the matrix 100 towards the semi-finished product 1F, said second force F2 being at least sufficient for allowing the stem of semi-finished product 1F to exit from the perforated channel 101 of the matrix 100, at the same time allowing said semi-finished product 1F free to rotate with respect to said matrix 100, thus extracting the semi-finished product 1F from the matrix (FIGS. 7l,7m).

Passing now to an analysis of FIGS. 8a-8d, the operation effected with threading tools consisting of flat combs is described hereunder, but, as previously mentioned, the threading tools can alternatively be rolls.

FIGS. 8a-8d show, in detail, consecutive phases of a preferred embodiment of step h. for producing, by means of a plastic deformation operation, a threaded portion on at least part of said stem of semi-finished product 1F.

In this embodiment, step h. comprises the following phases:
h1. preparing threading tools 201, 202 provided with threading profiles 203,
h2. inserting at least part of the stem of semi-finished product 1F between said threading tools,

h3. rolling said part of the stem 2F of semi-finished product 1F between said threading tools 201, 202 to form a threaded portion by means of a plastic deformation operation, obtaining the screw fitting 1 of the invention.

With respect to the equipment for implementing the method of the invention, and with reference to FIGS. 8a-8f, this comprises a moulding matrix 100 comprising a perforated channel 101 open on at least a side of the matrix 100 and defined by peripheral walls 102 from which at least one helical relief protrudes.

In an advanced version, in order to apply the force F1 indicated above, the equipment comprises a thrust tool 106 facing the matrix 100 on its side on which the perforated channel 101 opens; the thrust tool 106 is suitable for exerting the first axial force F1 on the head of the semi-finished product 1E and can be coupled with the head of the semi-finished product so that the head is free to rotate on itself.

According to an improvement, in order to apply the force F2 indicated above, the equipment also comprises an extraction pin (not shown) free to at least translate, preferably roto-translate inside the perforated channel 101 of the matrix 100 and destined for exerting the second axial force F2, in correspondence with a terminal end of said stem opposite that facing the head of the semi-finished product.

According to further improvements, the equipment also comprises a threading group for plastic deformation by means of rolling, comprising at least threading tools 201, 202 each provided with a threading profile 203, facing each other.

The threading tools can comprise both flat thread chasers and thread rolls.

The objectives indicated above have therefore been achieved.

Numerous variants of what has so far been described are obviously possible, all to be considered as being an integral part of the present invention.

The invention claimed is:

1. A screw fitting (1) for passage of fluids comprising:
a stem (2); and
an enlarged head (3) positioned at an end of the stem (2), the stem being at least partially provided with a threaded portion (21), the stem comprising at least a throat (4) for the passage of a fluid, formed on an outer portion the stem (2) and extending at least through the threaded portion (21),
wherein said throat (4) has a helical development around a longitudinal development axis of said stem (2), said stem (2) further comprising a smooth portion (22) which extends between the enlarged head (3) and the threaded portion (21), wherein an external diameter (d2) of the threaded portion (21) is larger than an external diameter (d1) of the smooth portion (22), the threaded portion (21) being produced by plastic deformation.

2. The screw fitting (1) according to claim 1, wherein the throat (4) extends through at least part of the smooth portion (22).

3. The screw fitting (1) according to claim 1, wherein said throat (4) starts in correspondence with the smooth portion (22) and ends in an area of the stem close to or coinciding with the threaded portion (21).

4. The screw fitting (1) according to claim 1, further comprising a terminal truncated-conical portion (23) of said stem, adjacent to the threaded portion (21) and facing a free terminal end of the stem (2) opposite to the end coupled to the enlarged head (3), wherein said throat (4) ends in correspondence with the terminal truncated-conical portion (23).

5. The screw fitting (1) according to claim 1, wherein said throat (4) has a depth greater than the depth of the threading of the threaded portion (21), thereby interrupting the thread where the thread and the throat meet.

6. The screw fitting (1) according to claim 1, wherein said throat (4) has a tilted or curved trend with respect to the longitudinal development axis of said stem (2).

7. The screw fitting (1) according to claim 1, wherein the screw fitting comprises a plurality of said throats (4).

8. A method of producing a screw fitting (1) for passage of fluids, said screw fitting (1) comprising a stem (2) and an enlarged head (3) positioned at an end of the stem (2), the stem being at least partially provided with a threaded portion (21), comprising at least a throat (4) for the passage of a fluid, the throat being defined on an outer portion of the stem (2) and extending at least through the threaded portion (21), the method comprising the following consecutive steps:
f. preparing a metallic semi-finished product comprising: a stem of semi-finished product, cylindrical and substantially smooth, and an enlarged head of the metallic semi-finished product, provided with at least an internal imprint for a tool;
g. forming, by plastic deformation, at least a helical throat on at least part of said stem of said metallic semi-finished product; and
h. forming, by plastic deformation, a threaded portion on at least part of said stem of said metallic semi-finished product.

9. The method according to claim 8, further comprising, before step (g), the following steps of generating the metallic semi-finished product:
a. preparing a piece of metal wire having a pre-established length and diameter;
b. extruding said piece of metal wire for at least part of its length to create the stem of the metallic semi-finished product with a diameter smaller than a diameter of the piece of wire and a head of the metallic semifinished product having a first diameter larger than the diameter of the piece of wire;
c. effecting a first swaging of said head of the metallic semi-finished product until a second diameter, which is larger than the first diameter, is obtained;
d. effecting a second swaging of said head of the metallic semifinished product to create at least an external imprint thereon; and
e. effecting a third swaging of said head to create at least the internal imprint for the tool,
steps d. and e. being performed either alternatively or combined with each other.

10. The method according to claim 8, wherein step (g) comprises the following steps:
g1. preparing a molding matrix comprising a perforated channel defined by peripheral walls, in which there is at least one helical relief substantially complementary to the at least one helical throat to be formed on said stem of said metallic semi-finished product;
g2. inserting said stem of said metallic semi-finished product in said perforated channel;
g3. exerting a first axial force with respect to a longitudinal axis of said stem of said metallic semi-finished product, applied in correspondence with the head of said metallic semi-finished product and directed towards said matrix, said first axial force being at least sufficient for enabling at least part of the stem of said metallic semi-finished product to penetrate the perforated channel of the matrix, at the same time enabling said semi-finished product to rotate freely with respect to said matrix, so as to form the throat by plastic deformation of at least part of the stem of said metallic semi-finished product; and
g4. exerting a second axial force with respect to the longitudinal axis of said stem of said metallic semi-finished product, applied in correspondence with a terminal end of said stem opposite the end facing the head of said metallic semifinished product, said second force being directed from the matrix towards the metallic semi-finished product, said second force being at least sufficient for enabling the stem of said metallic semi-finished product to exit from the perforated channel of the matrix, at the same time enabling said metallic semi-finished product to freely rotate with respect to said matrix, thus extracting the semi-finished product from the matrix.

11. The method according to claim 8, wherein step (h) comprises the following steps:
h1. preparing flat threading tools provided with male threading profiles;
h2. inserting at least part of the stem of said metallic semi-finished product between said threading tools; and
h3. rolling said part of the stem of said metallic semi-finished product between said threading tools to form a threaded portion by plastic deformation.

12. Equipment for implementing a method of producing a screw fitting (1) for passage of fluids, said screw fitting (1) comprising a stem (2) and an enlarged head (3) positioned at an end of the stem (2), the stem being at least partially provided with a threaded portion (21), comprising at least a throat (4) for the passage of a fluid, the throat being defined on an outer portion of the stem (2) and extending at least through the threaded portion (21), the method comprising the following consecutive steps:
f. preparing a metallic semi-finished product comprising: a stem of semi-finished product, cylindrical and substantially smooth, and an enlarged head of the metallic semi-finished product, provided with at least an internal imprint for a tool;
g. forming, by plastic deformation, at least a helical throat on at least part of said stem of said metallic semi-finished product and
h. forming, by plastic deformation, a threaded portion on at least part of said stem of said metallic semi-finished product,
said equipment comprising:
a molding matrix (100) comprising a perforated channel (101) open on at least one side of the molding matrix and defined by peripheral walls (102), from which at least one helical relief protrudes.

13. The equipment according to claim 12, further comprising a thrust tool (106) facing said matrix (100) on a side of said matrix on which the perforated channel (101) opens, and adapted to exert said first axial force with respect to a longitudinal axis of said stem of the semi-finished product, applied in correspondence with a head of the semi-finished product and directed towards said matrix, said thrust tool being coupled with said head of said semi-finished product rotatably free.

14. The equipment according to claim 12, further comprising an extraction pin at least partially translatingly housed inside said perforated channel (101) of the matrix and adapted to exert a second axial force, with respect to a longitudinal axis of said stem of said semi-finished product, in correspondence with a terminal end of said stem opposite the end facing the head of the semi-finished product.
